(19) United States
(12) Patent Application Publication
(10) Pub. No.: US 2005/0001837 A1
(43) Pub. Date: Jan. 6, 2005

(54) Method and internet based software for graphing sport statistics

(76) Inventor: Michael P. Shannon, Chicago, IL (US)

Correspondence Address: BRENT A. HAWKINS, 311 S. WACKER DRIVE, 53RD FLOOR, CHICAGO, IL, 60606-6622, US

(21) Appl. No.: 10/376,017

(22) Filed: Feb. 28, 2003

Related U.S. Application Data
(60) Provisional application No. 60/361,145, filed on Mar. 1, 2002.

(51) Int. Cl. G06T 11/20

(52) U.S. Cl. 345/440

(57) ABSTRACT

A system and method for graphing sport statistics is disclosed. The method comprises the steps of: accessing a database storing sport data; receiving an input transmission of at least one sport entity identifier, wherein the sport entity identifier corresponds to either a player or a team; receiving an input transmission of at least one time interval; receiving an input transmission of at least one desired sport statistic and a plurality of sport data corresponding to the at least one sport entity and time interval identifier from the database; generating a graphical user interface image of a graph chart; and, plotting the transmitted sport data at a point corresponding to a correlative magnitude and point in time on the graphical user interface image; and, generating a graphical representation of the at least one desired sport statistic over the at least one time interval and corresponding to the at least one sport entity identifier.

### RELATED APPLICATIONS

This application claims the benefit of U.S. Provisional Application No. 60/361,145, filed Mar. 1, 2002.

### TECHNICAL FIELD

The invention relates to a system and method for graphing sport statistics. More particularly, the invention is directed to an Internet based system and method for graphing statistical differentials, or margins, between sports players and/or teams and their respective opponents over time.

### BACKGROUND OF THE INVENTION

The growth of the Internet has fueled the development of a variety of Internet-based forums in which to obtain sport statistics, and provide shared access to such sport statistics to communities of Internet users. These include web pages that can be downloaded and displayed concurrently by many different Internet users, as well as a wide variety of interactive, Internet-based statistic gathering systems.

Sports enthusiasts, including participants in Internet community sports, and Internet sports prognostication and wagering, often wish to obtain information regarding how a team or player in a particular sport has performed against different opponents or against the point-spread when playing under a variety of circumstances (e.g., day or night, home or away, grass or turf, beginning or end of road trips, on their birthdays, when league standing is in jeopardy, etc.). For example, participants in “fantasy sports” often desire to know how two teams match up against each other and how individual performances may be deduced from past performances. Such participants also have analysis needs that are not currently fulfilled by daily and/or summary statistics.

For example, participants playing in fantasy sports leagues often wish to obtain information as to how players or teams match up with each other by statistical category (e.g., points, rebounds, turnovers, pass defense, weight of the offensive line, etc.). Additionally, participants desire to obtain information relating to how a team has trended over varying time intervals (e.g., an entire season, the past thirty days, the past sixty days, etc.). A participant may also seek information relating to team or player trends as they relate to performance at home or on the road, as well as trends indicating how the two opponents have performed against each other in previous meetings. Furthermore, participants desire to acquire this information in a timely and easily accessible manner, and often with respect to multiple teams and multiple sports.

Typically, participants have turned to websites affiliated with broadcasting companies, such as ESPN, USAToday, CBS Sportsline, at which sport statistics may be found. While websites such as these have met with some degree of success in providing software to graph sport data, there are still some inherent drawbacks. In particular, none of these sites display comparative sports statistical differentials, or margins, of multiple sports contestants, for multiple sports statistics, over dynamically selected time intervals, against their respective opponents. For example, a user of the CBS Sportsline website can access actual value statistics of both individual players and teams. A user may not, however, chart statistical differentials, or margins, of players or teams versus their opponents over time. Nor can a user of CBS Sportsline's statistical graphing interface overlay graphs for multiple statistical categories on the same graph, allowing the user to deduce inherent correlations of one statistical category to another. Thus, a need has been recognized by sports enthusiasts, Internet applications developers and service providers for an Internet-based forum that provides a legal, and acceptable medium in which Internet-users can access and chart comparative statistics of players and teams of various sporting events.

The present invention is provided to solve the problems discussed above and other problems, and to provide advantages and aspects not provided by prior computer software or statistical graphing tools of this type.

### SUMMARY OF THE INVENTION

According to one aspect of the present invention a method for graphing sport statistics is disclosed. The method comprises the steps of: accessing a database storing sport data; receiving an input transmission of at least one sport entity identifier, wherein the sport entity identifier corresponds to either a player or a team; receiving an input transmission of at least one time interval; receiving an input transmission of at least one desired sport statistic and a plurality of sport data corresponding to the at least one sport entity desired sport statistic, and time interval identifier from the database; generating a graphical user interface image of a graph chart; plotting the transmitted sport data at a point corresponding to a correlative magnitude and point in time on the graphical user interface image; and, generating a graphical representation of the at least one desired sport statistic over the at least one time interval and corresponding to the at least one sport entity identifier.

According to another aspect of the present invention, a computer program for graphing sport statistics is disclosed. The computer program is comprised of a plurality of computer code segments for performing the above method.

These and other objects and advantages will be made apparent from the following description of the drawings and detailed description of the invention.

### BRIEF DESCRIPTION OF THE DRAWINGS

FIG. 1 is a collection of charts illustrative of the comparative graphs generated by the present invention; and,

FIG. 2 is a database spreadsheet printout of possible trends from which the graphs in FIGS. are generated.

### DETAILED DESCRIPTION

While this invention is susceptible to embodiment in many different forms, there is shown in the drawings, and will herein be described in detail, a preferred embodiment of the invention with the understanding that the present disclosure is to be considered as an exemplification of the principles of the invention and is not intended to limit the broad aspect of the invention to the embodiment illustrated.

The present invention relates to an Internet-based software having a network interface, typically an Internet website, that functions as a platform for analyzing and displaying a graphical representation of statistical sports data. The website provides services to users desiring to access comparative statistical data of individual and team athletic performances. Such users can include participants in community “fantasy” sports competitions or those interested in evaluating odds for purposes of engaging in legal wagering. The software is also useful for administrators, scouts and owners of athletic teams desiring to obtain comparative statistical data concerning an athlete or team for purposes of game-planning or acquisition.

The present software allows a user to plot actual, maximum, minimum, and average statistics of a player, position or team over a selected time interval. The software also allows a user to chart the margin or differential between a player and/or team and its competitors such that more useful data may be obtained than actual magnitudes of a particular statistical category. The present software also allows a user to plot average statistics relinquished by a specified team, position, player or combination of players to a respective opponent over a selected time interval.

More specifically, the software generates an interface comprising distinct sections, each corresponding to a sporting activity. The sections may include, for example, football, basketball, baseball, hockey and soccer sections. While visiting a section of the website corresponding to a particular sport, a user may graph sports statistics of a specified player/players or team/teams over a specified time interval. For example, a user visiting the basketball section of the website can chart, on an interactive graph, the number of home wins that Team A has accumulated over the previous thirty days, as well as the margin of victory. A user can then overlay the interactive graph with a graphical representation of the statistical performance of Team B over the same or different time interval. A user may also overlay several different statistics for a single or plurality of players or teams on a single interactive graph. This would be done to determine what relationship one or more statistical categories have to one another over time. Furthermore, the time or date interval over which the statistics are charted may be chosen dynamically. Additionally, a user may chart how an individual/team has trended verses a chosen opponent in more than one statistical category. Also, a user can overlay the interactive graph with one ore more actual point-spreads and/or run-lines from multiple sports books for the purposes of legal wagering. Some examples of the statistical categories that can be charted in accordance with the present invention are as follows:

### BASKETBALL

Entire Team

Actual Points—over time

Opponents Points—over time

Average Points—straight line

Average Points vs. Tonight's Opponent

Points Margin (Differential between Actual and Opponents)

Point Spread

Maximum Points

Minimum Points

All above can be graphed/charted using the different chart modes mentioned earlier, as well as the custom date range mentioned earlier.

Position by Position

Actual Combined Points of all (Position)

Actual Points of Opponents

Points/48 Minutes (Actual Combined Points divided by Sum of Minutes divided by 48)

Opponent Points/48 Minutes

Average Points

Average Points/48 Minutes

Average Points Relinquished by Tonight's Opponent

Average Points/48 Relinquished by Tonight's Opponent

Actual Points Margin or Differential (Actual Points minus Opponent Actual Points)—relative to zero

Points/48 Margin or Differential (Points/48—Opponent Points/48)—relative to zero

Maximum Points

Opponent Maximum Points

Minimum Points

Opponent Maximum Points

All above can be graphed/charted using the different chart modes mentioned earlier, as well as the custom date range mentioned earlier. All of the above can be graphed (charted for each position (Point Guards, Shooting Guards, Small Forwards, Power Forwards, Centers).

Statistical Categories

Field Goal Attempts

Field Goals

Free Throw Attempts

Free Throws

3-Point Attempts

3-Point Goals

Offensive Rebounds

Defensive Rebounds

Total Rebounds

Assists

Steals

Blocks

TurnOvers

Personal Fouls

### BASEBALL

Entire Team—Offense

Actual Runs

Opponent Actual Runs

Average Runs

Opponent Average Runs

Runs Margin or Differential (Actual Runs—Opponent Actual Runs)

Run Line (Equivalent to Point Spread)

Maximum Runs

Opponent Max Runs

Minimum Runs

Opponent Min. Runs

Entire Team—Offensive Statistical Categories

Games

At Bats

Runs

Hits

Doubles

Triples

Home Runs

Runs Batted In

Stolen Bases

Caught Stealing

Base on Balls

Intentional Base on Balls

Strike Outs

Sacrifices

Sacrifice Flies

Hit by Pitch

Past Balls

Put Outs

Assists

Errors

Individual Batters

Actual Runs

Runs per 4 plate appearances

Actual Opponent Runs

Opponent Runs per 4 plate appearances

Average Runs

Average Runs per 4 plate appearances

Average Runs vs Tonight's Opponent

Average Runs per 4 plate appearances vs. Tonight's Opponent

Runs Margin or Differential (Runs minus Opponent Runs)

Runs per 4 Plate appearances Margin or Differential (Runs/4 PA—Opponent Runs/4 PA)

All above can be graphed/charted using the different chart modes mentioned earlier, as well as the custom date range mentioned earlier. All of the above can be graphed/charted for different positions (Catcher, 1^{st} Base, 2^{nd} Base, 3^{rd} Base, Shortstop, Outfield, Designated Hitter/Hitter Pitcher).

Individual Batters—Statistical Categories

Games

At Bats

Runs

Hits

Doubles

Triples

Home Runs

Runs Batted In

Stolen Bases

Caught Stealing

Base on Balls

Intentional Base on Balls

Strike Outs

Sacrifices

Sacrifice Flies

Hit by Pitch

Past Balls

Put Outs

Assists

Errors

Individual Pitchers

Actual Runs Given Up

Runs per nine innings

Actual Opposing Pitcher Runs Given Up

Opposing Pitcher Runs Given Up per nine innings

Average Runs Given Up

Average Runs Given Up per nine innings

Average Runs Scored by Tonight's Opponents

Average Runs per nine innings scored by Tonight's Opponent

Runs Given Up Margin or Differential (Runs Given Up minus Opposing Pitcher Runs Given Up)

Runs Given Up per nine innings Margin or Differential (Runs/9 innings—Opposing Pitcher Runs Given Up/nine innings)

All above can be graphed/charted using the different chart modes mentioned earlier, as well as the custom date range mentioned earlier. All of the above can be graphed/charted by position (Starters, Middle Relievers, Closers, or Entire Ballpen)

Individual Pitchers—Statistical Categories

Games Started

Complete Games

Save Opportunities

Quality Starts

Games Finished

Wins

Losses

Holds

Innings Pitched

Saves

Innings Pitched

Hits

Base on Balls

Intentional Base on Balls

Blown Saves

Holds

Saves

BlownSaves

Hit by Pitch

Runs

Earned Runs

Strike Outs

Doubles

Triples

Home Runs

Stolen Bases

caught Stealing

Balks

Wild Pitches

Batters Faced

No Hitters

No Hit Outings

While the above, are examples of some of the statistical categories that can be graphed by the present invention, the invention is not meant to be limited to these specific categories. It is contemplated that like statistics may be graphically presented for other sports such as hockey, volleyball, tennis or other sports suitable for such applications.

A statistical modifier is also included to provide a “handicap” that accounts for gaps in player playing time when comparing team statistics. This function is used to measure the contributions of reserve players that substitute for primary players at a given position. For example, in graphing a statistic of a single position for a specified basketball team, the statistical modifier will account for a player's statistical performance per minute/per game. Accordingly, a resulting graph will account for the time that each player at that particular position was out of the game. With reference to another example, the statistical modifier will account for the number of at-bats, or the number of innings played, for a baseball player. According to a preferred embodiment of the present invention, the statistical modifiers for basketball, baseball and hockey are as follows:

| SPORT/POSITION | MODIFIER |
|---|---|
| Professional Basketball/All | Per 48 minutes |
| College Basketball/All | Per 40 minutes |
| Baseball/Pitchers | Per 9 innings pitched |
| Football/Offensive Players | Per average offensive plays per game |
| Football/Defensive Players | Per average defensive plays per game |
| Baseball/Batters | Per average plate appearances per game |
| Professional Hockey/All | Per 60 minutes |

The present invention also incorporates a position modifier to compensate for potential comparisons between players performing at different positions. For example, a user may desire to obtain a statistical differential between a specified statistical category of a certain pitcher versus a specified statistical category of a certain batter. The software is adapted to chart, for example, the number of strike-outs per nine-innings pitched over a three month period for a Pitcher A versus the number of strike-outs a Batter B has over that same three month period.

In a preferred embodiment, the software of the present invention is accessed through the Internet. As will be appreciated by one skilled in the art, the Internet comprises a vast number of computers and computer networks that are interconnected through communication links. The interconnected computers exchange information using various services, such as electronic mail and the World Wide Web (“WWW”). The WWW allows a server computer system (i.e., Web server or Website) to send graphical web pages of information to a remote client computer system. The remote client computer system can then display the web pages on a display screen such as a cathode ray tube or the like.

It will also be appreciated by those skilled in the art that each resource (e.g., computer or Web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page request, it typically displays the web page using a browser. A browser is a special-purpose application program that effects the requesting of web pages and the displaying of web pages on a display screen.

Currently, web pages are typically defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other web pages available on that server computer system or other server computer systems. The computer program for graphing sporting statistics is accessible via such a Web page, and is described in more detail hereinafter.

The computer program comprises a series of software code segments. In particular, the software comprises a code segment that receives an input transmission of at least one sports entity identifier, which is input by a user. The computer program also has a code segment for accessing a database storing sports data, wherein the sports data comprises a plurality of statistical events occurring at a point in time, each statistical event corresponding to one of a plurality of sports entity identifiers. The sports entity identity identifier may be a player name, player number, team name, position, team logo or any other identifier suitable for identifying a player or team. It is contemplated that the identifier may be a selectable graphical user interface (GUI) image in communication with a database of players and/or teams. Alternatively, the GUI image could provide an icon that corresponds to a well-known identifier, such as a team logo or city name. Alternatively, the GUI image could display a list of players or teams organized in an acceptable format. For example, the GUI image could display a list of teams organized according to divisions or players according to position.

The computer program also includes a code segment for receiving an input transmission of at least a first time interval. It is contemplated that the time interval be input by user keystroke or any other method suitable for selecting a beginning and ending time or date. The typical ending time or date is the present. For example, it is contemplated that the time interval be selected from a database of predetermined intervals, such as a selectable drop-down menu, a radio button, or a generated GUI image, such as a calendar. Typically, the time interval will be set in terms of days, weeks, months or seasons. However, it is contemplated by the present invention that statistics may be obtained in “real-time.” Accordingly, the time intervals may be set in terms of minutes or seconds.

The computer program also has a code segment for receiving an input transmission from a database of sports statistics. The input transmission corresponds to the sports entity identifier and time interval specified by the user. For example, the database will transmit and the computer program will receive a baseball team's team earned run average (ERA) over a sixty-day period.

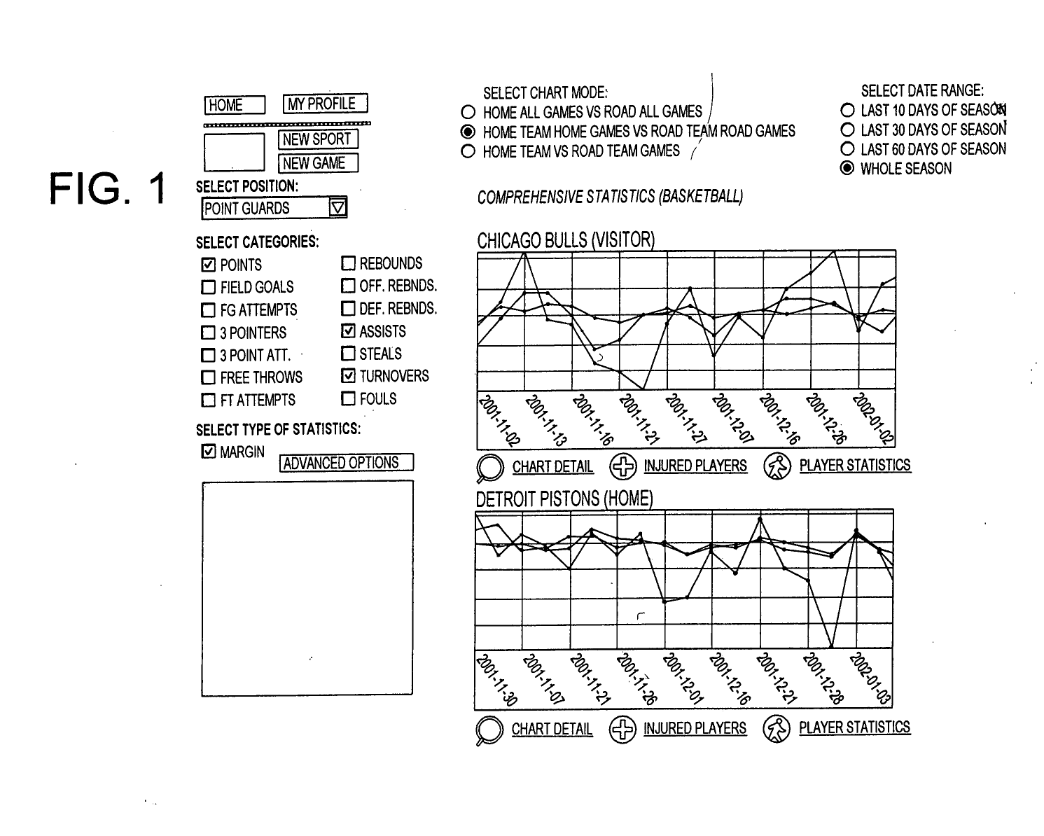

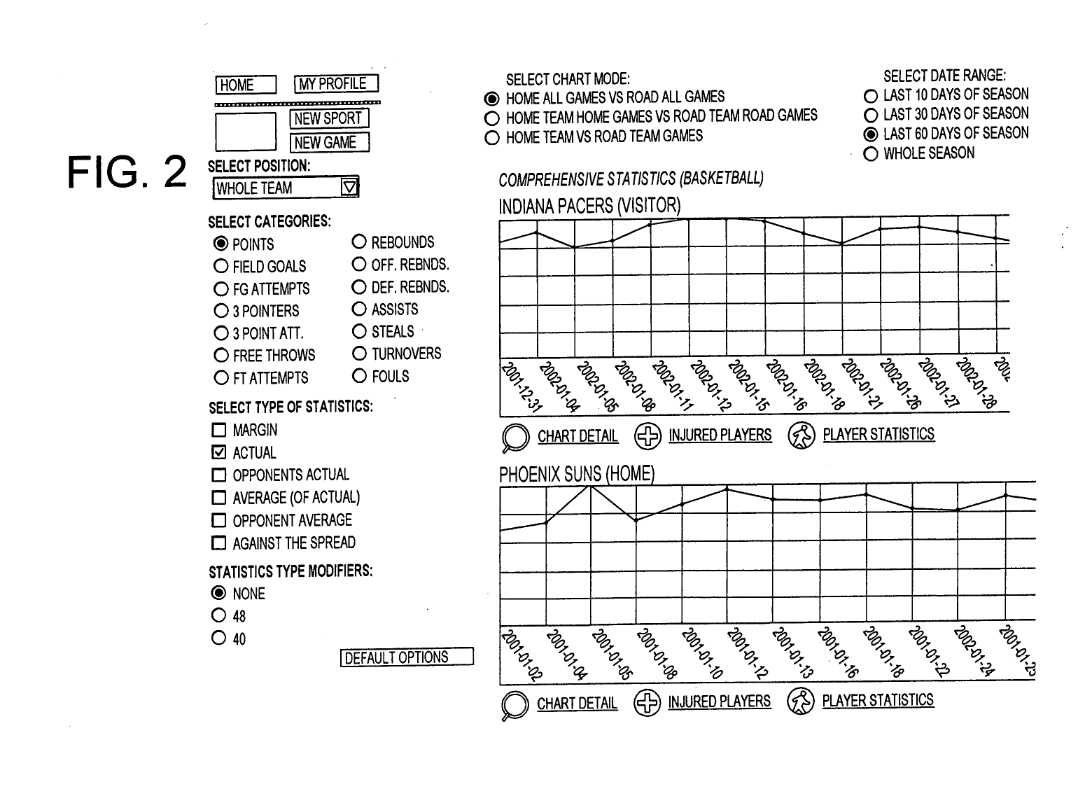

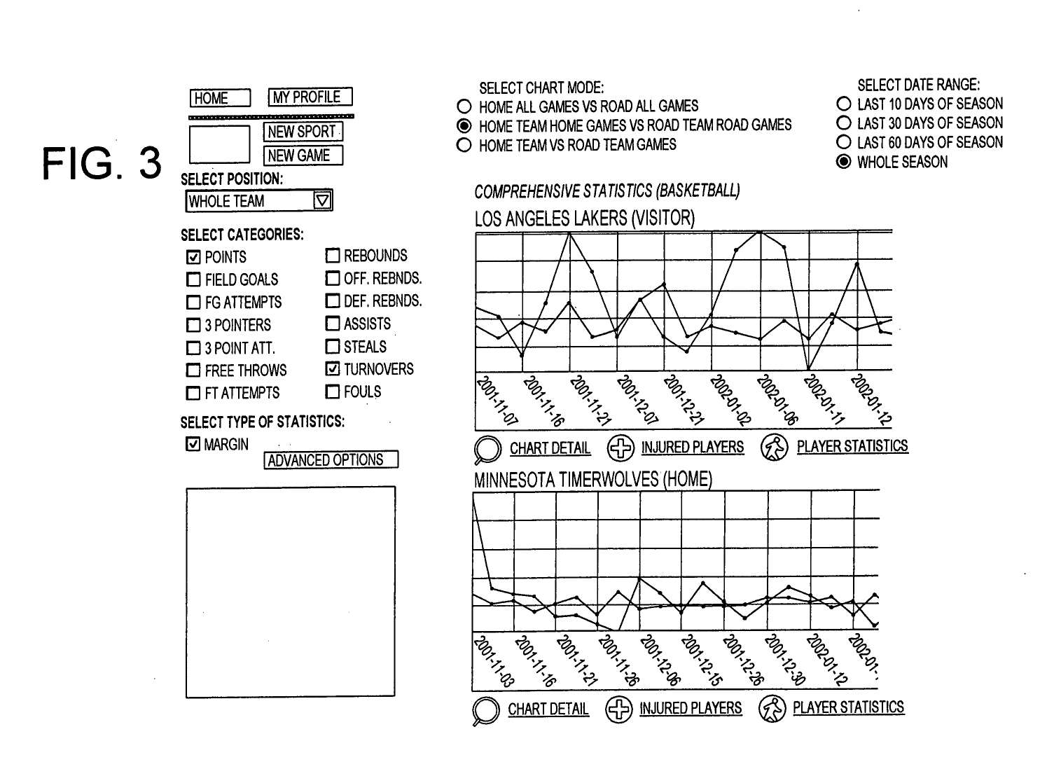

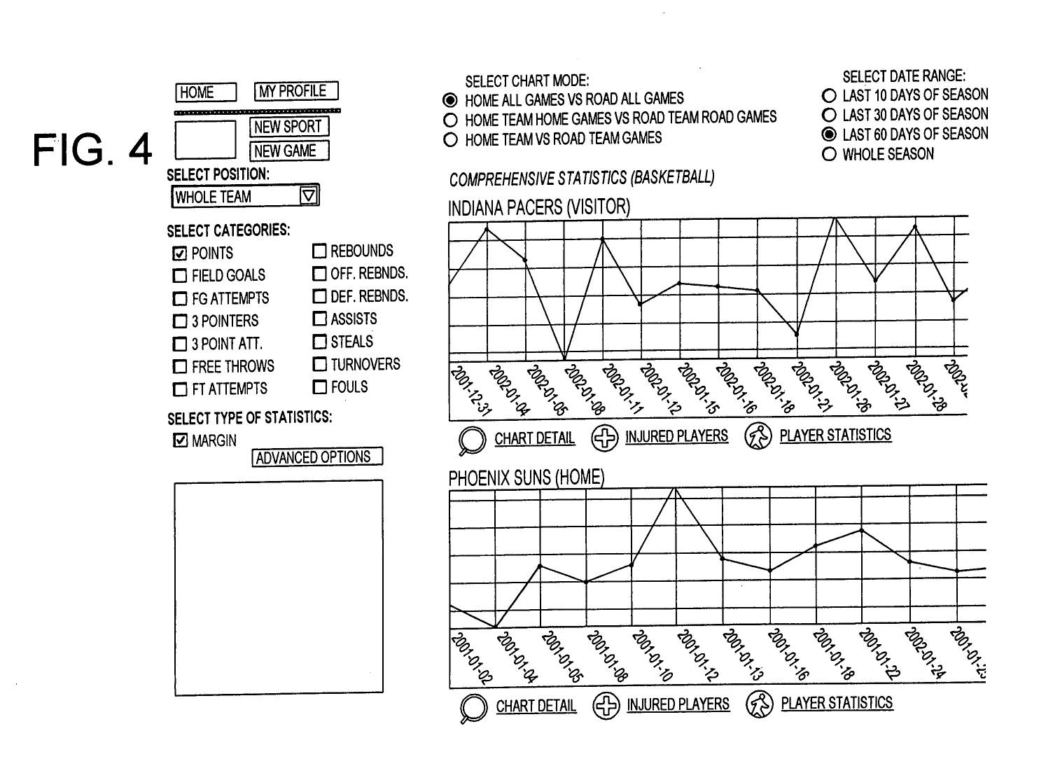

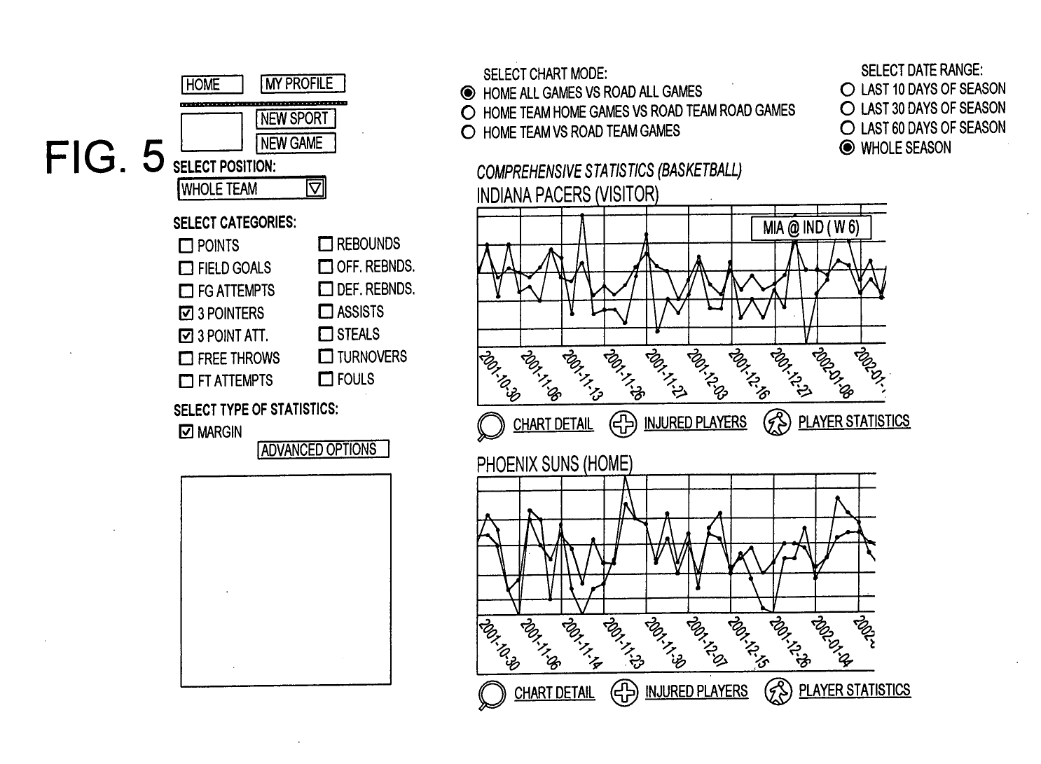

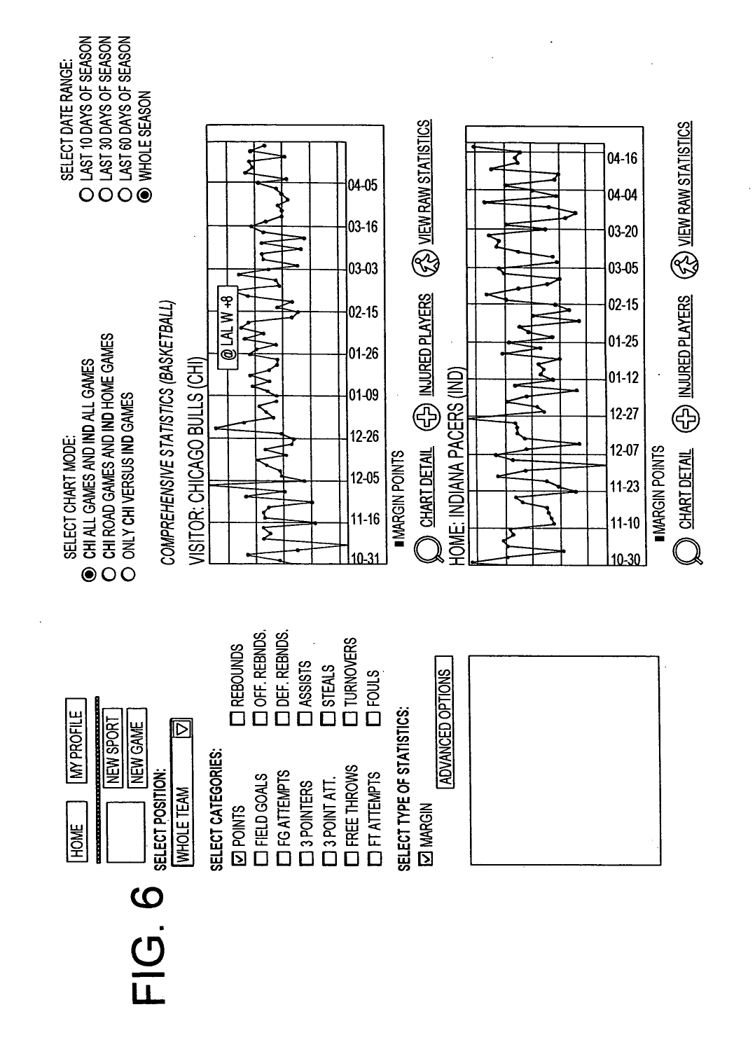

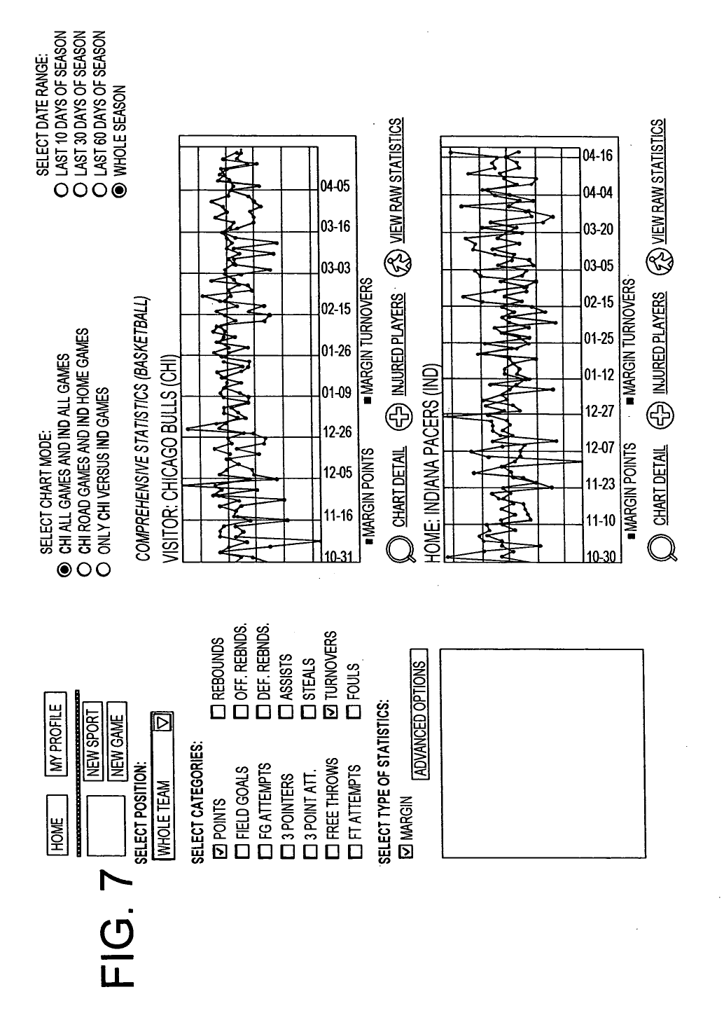

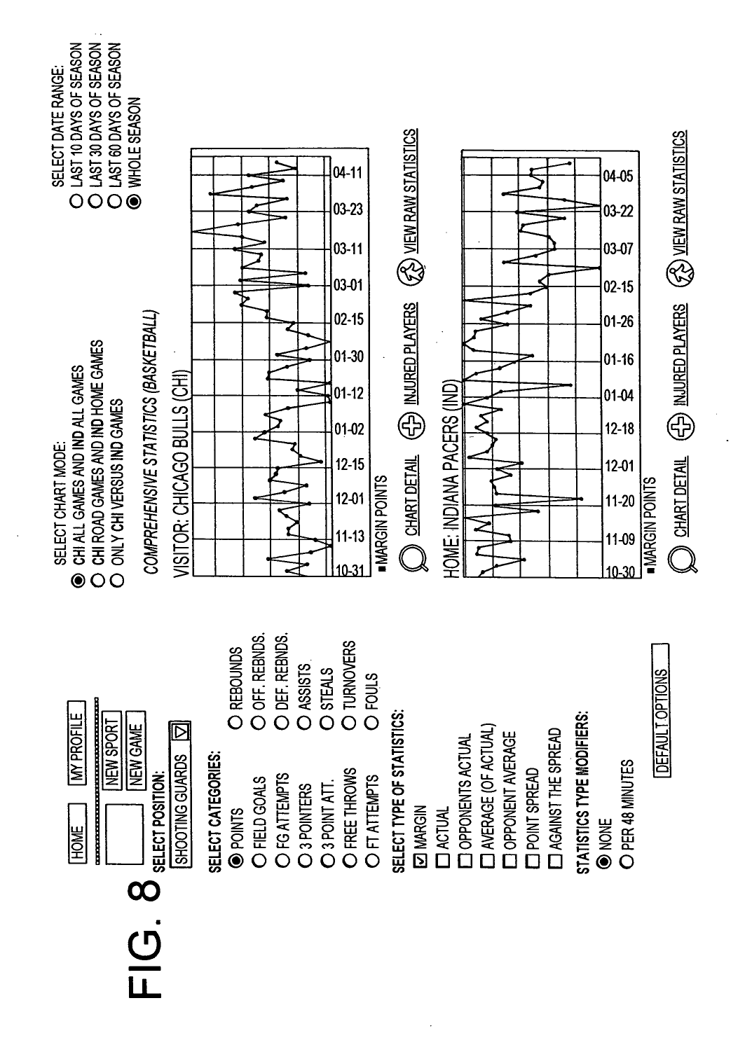

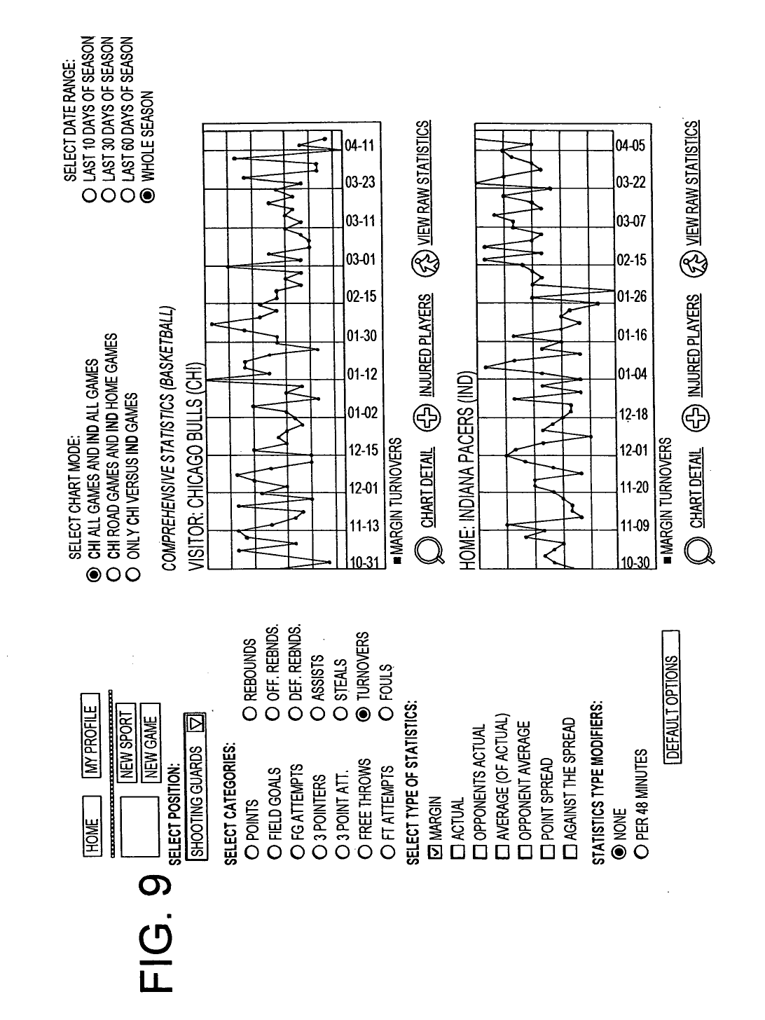

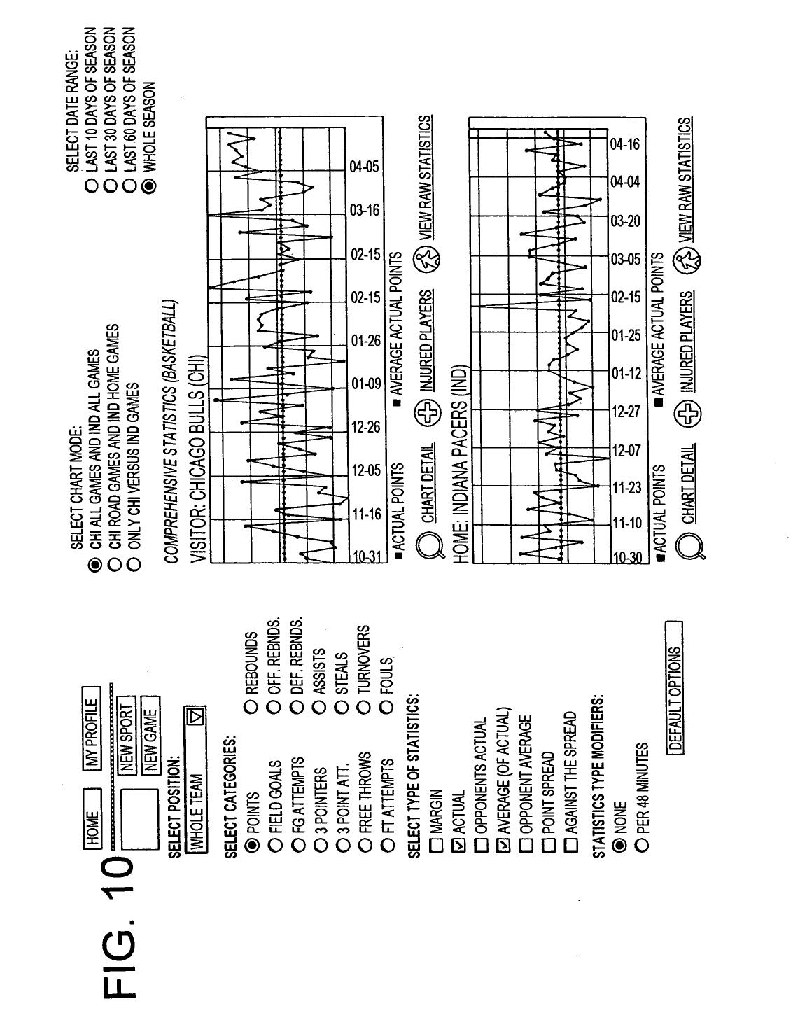

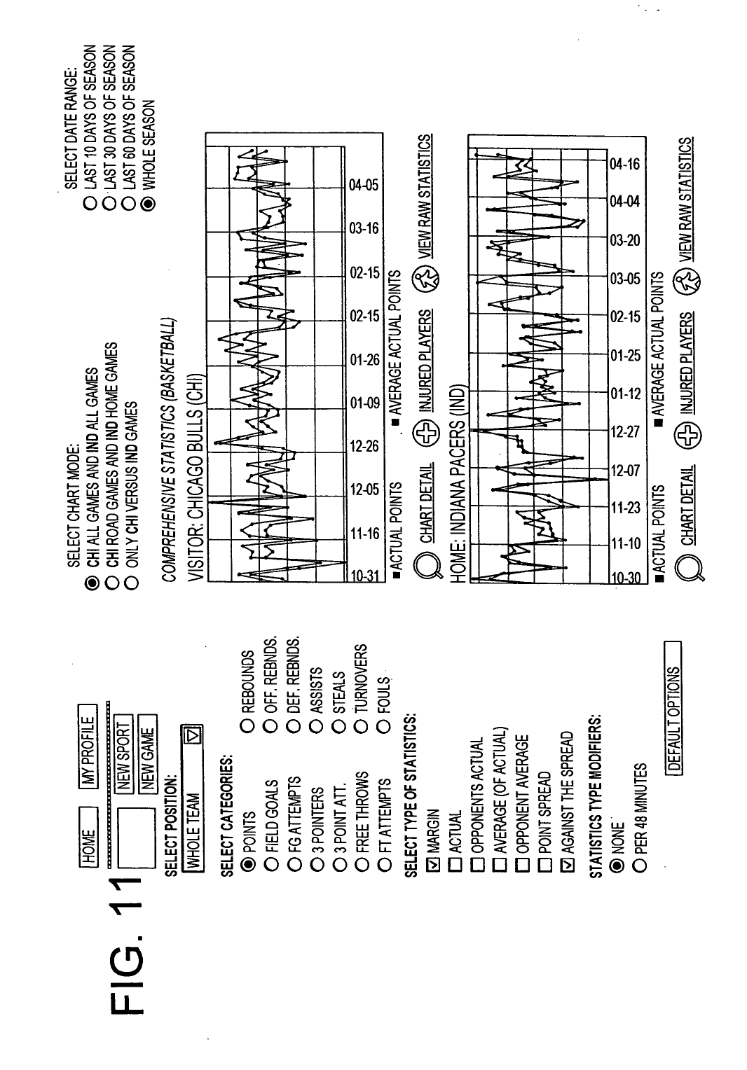

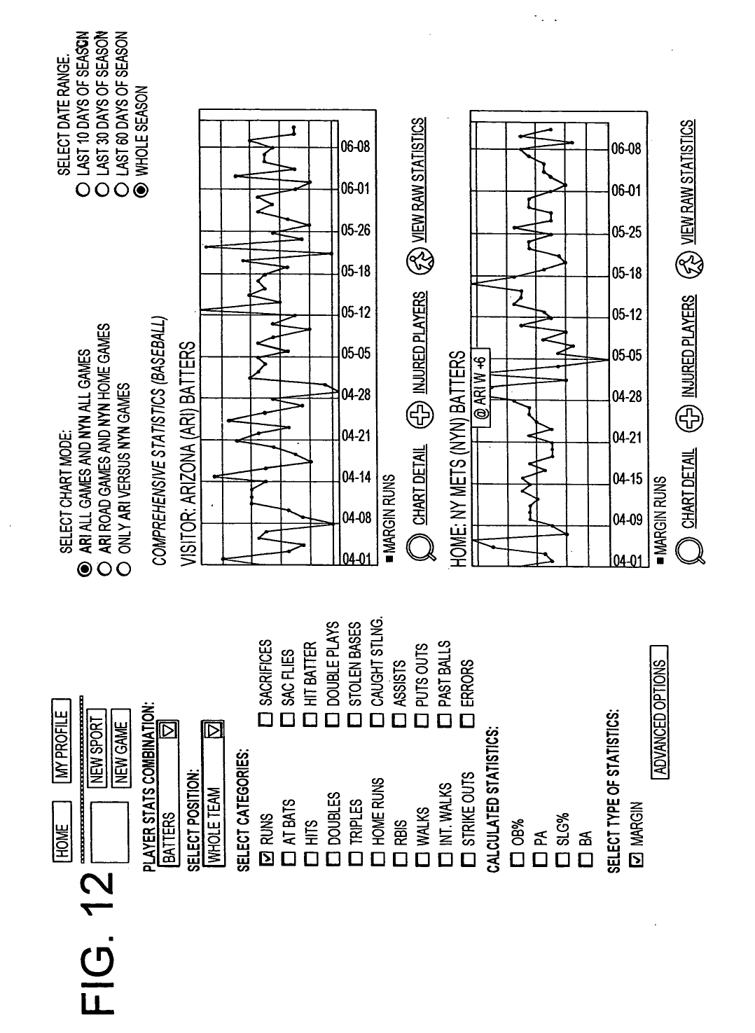

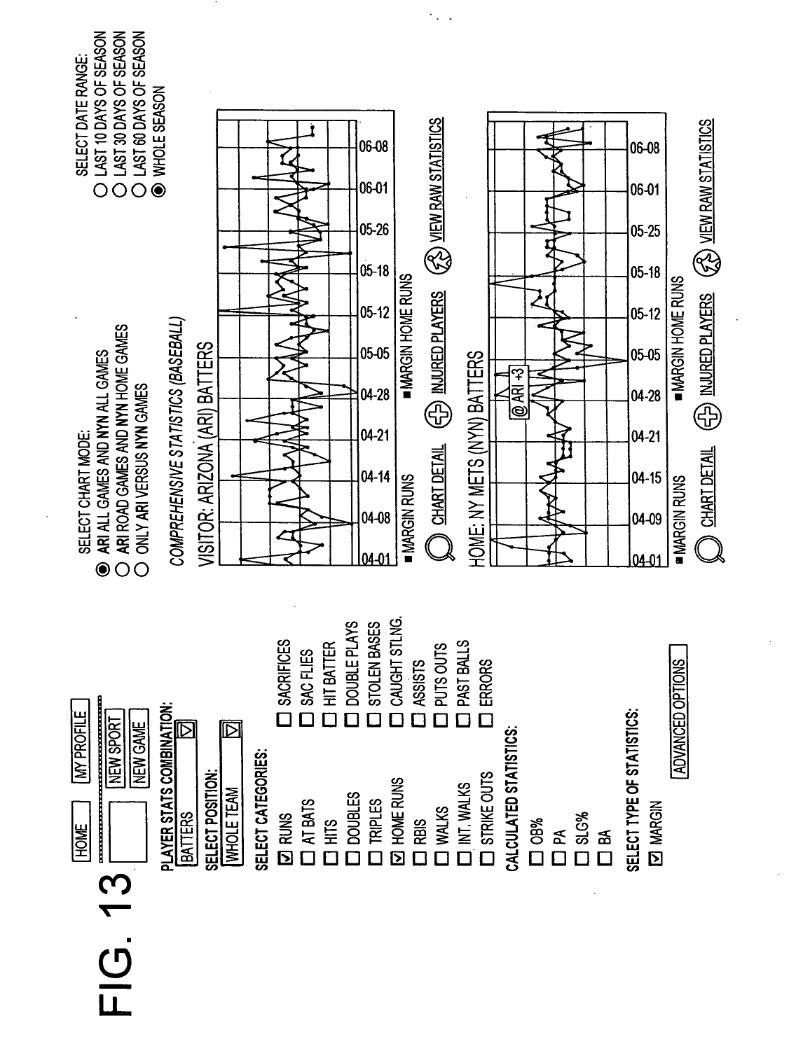

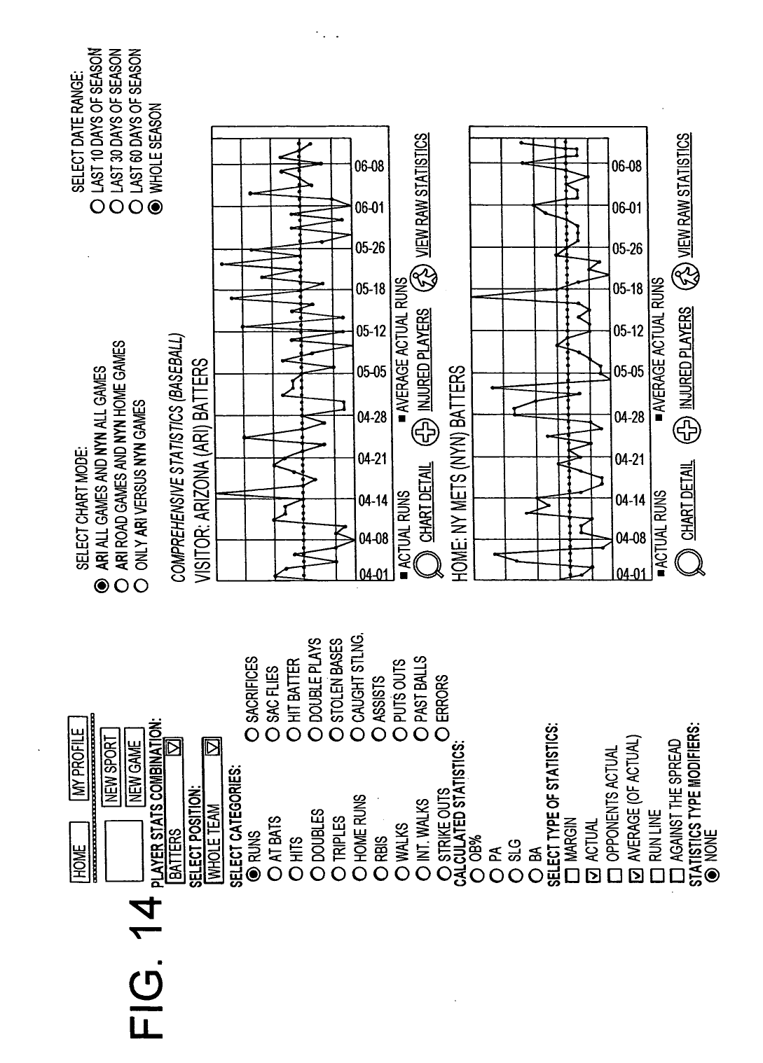

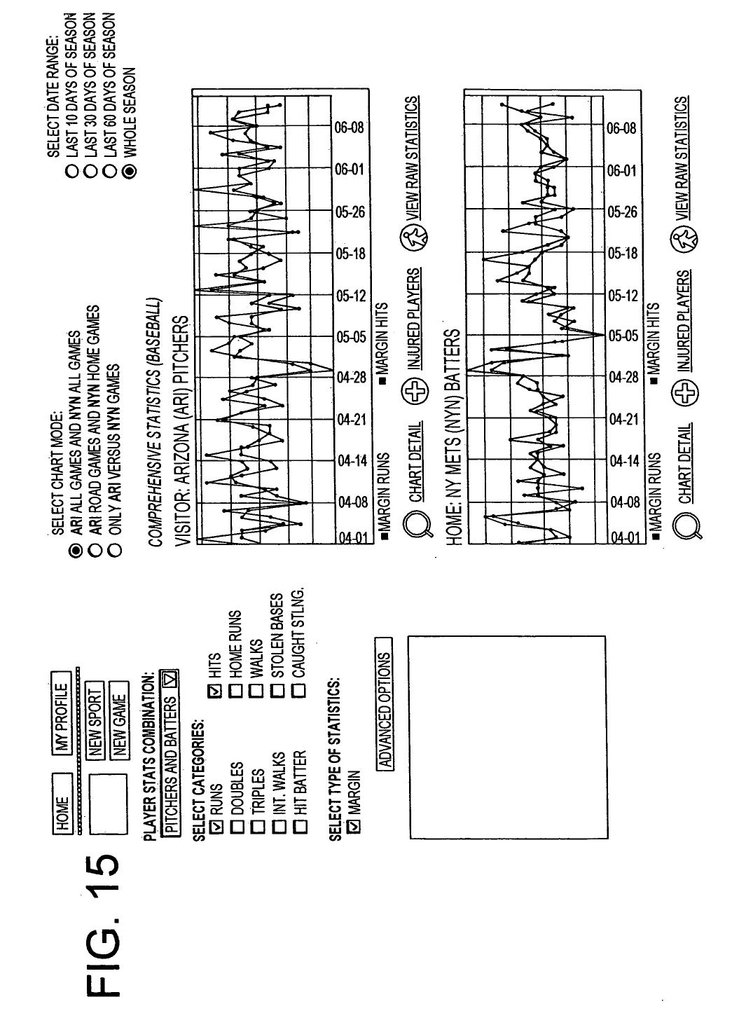

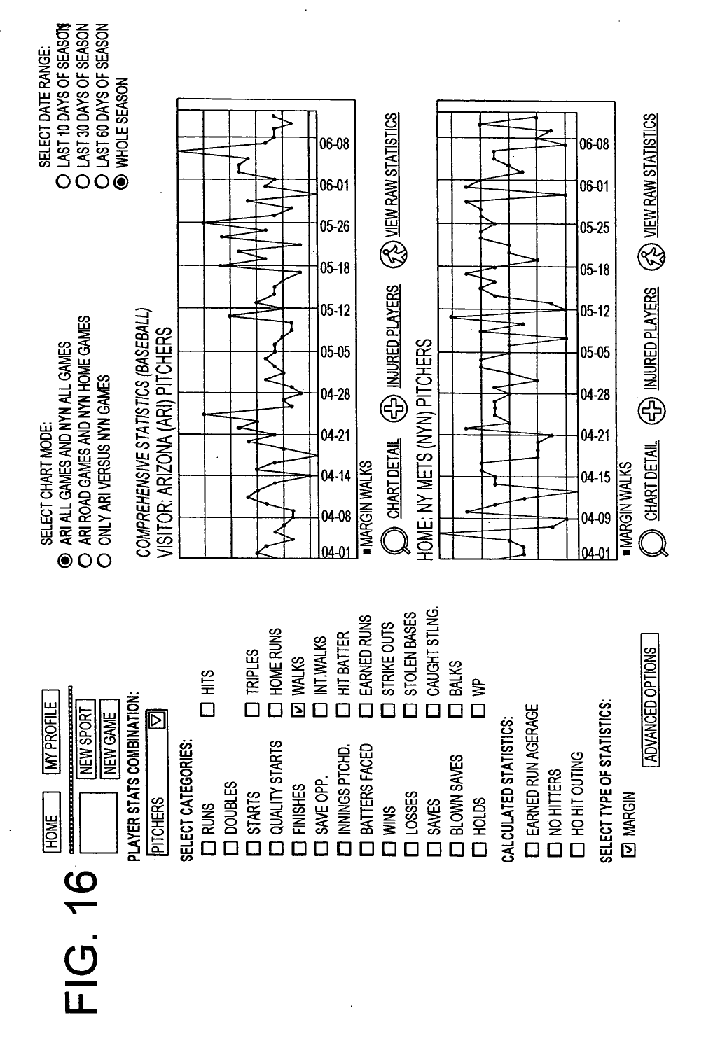

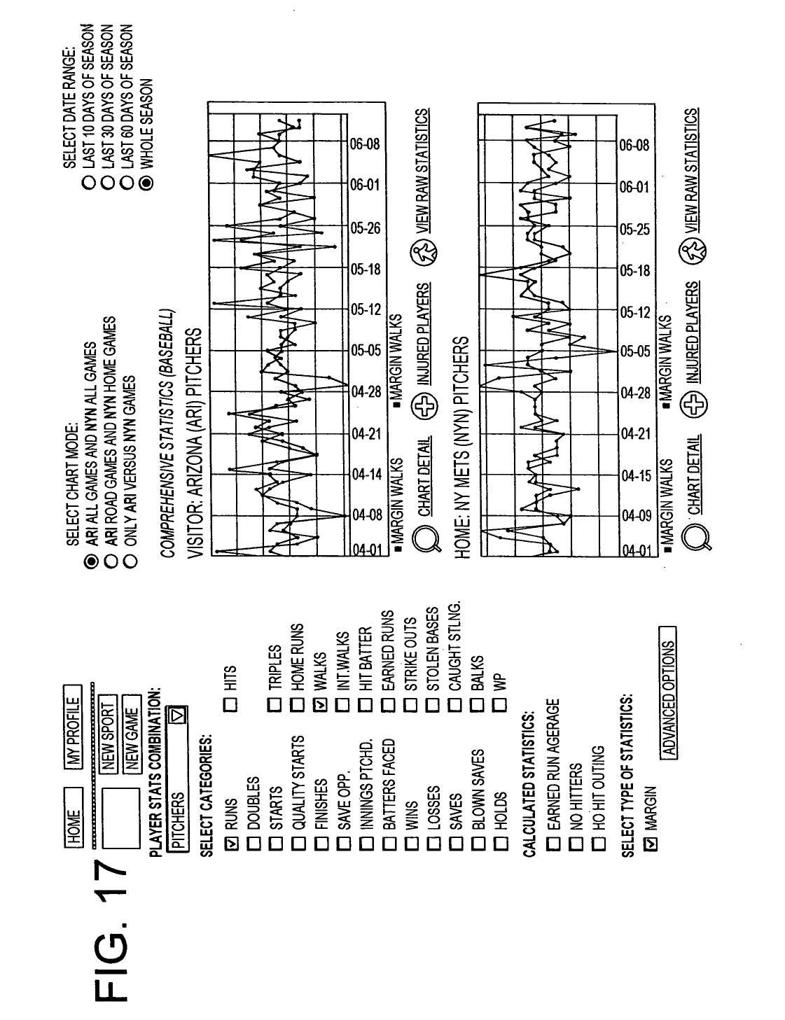

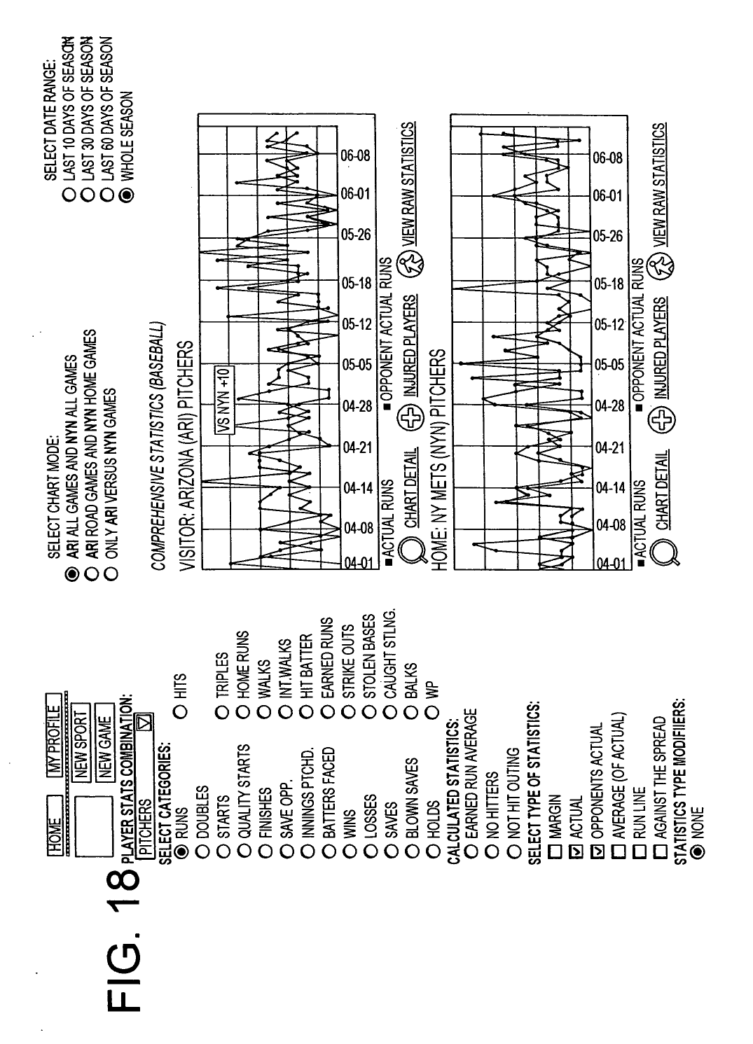

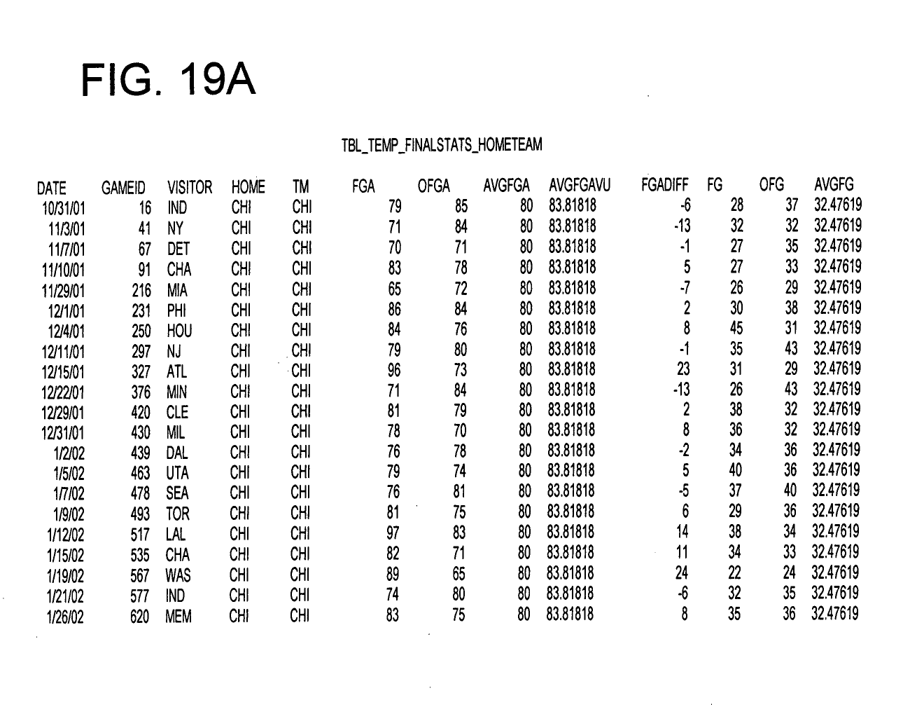

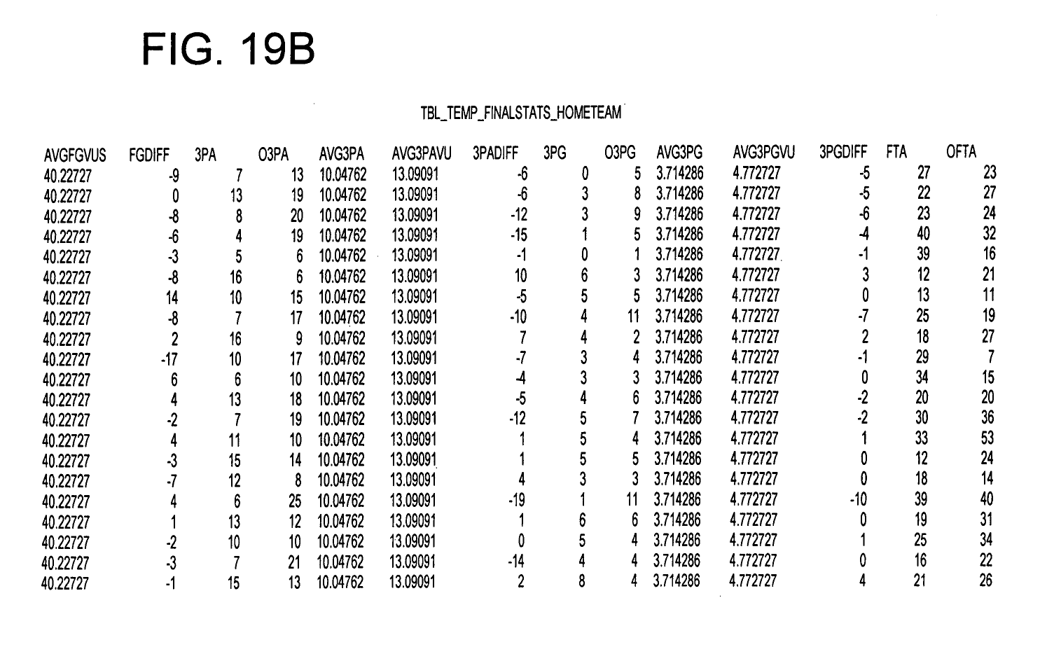

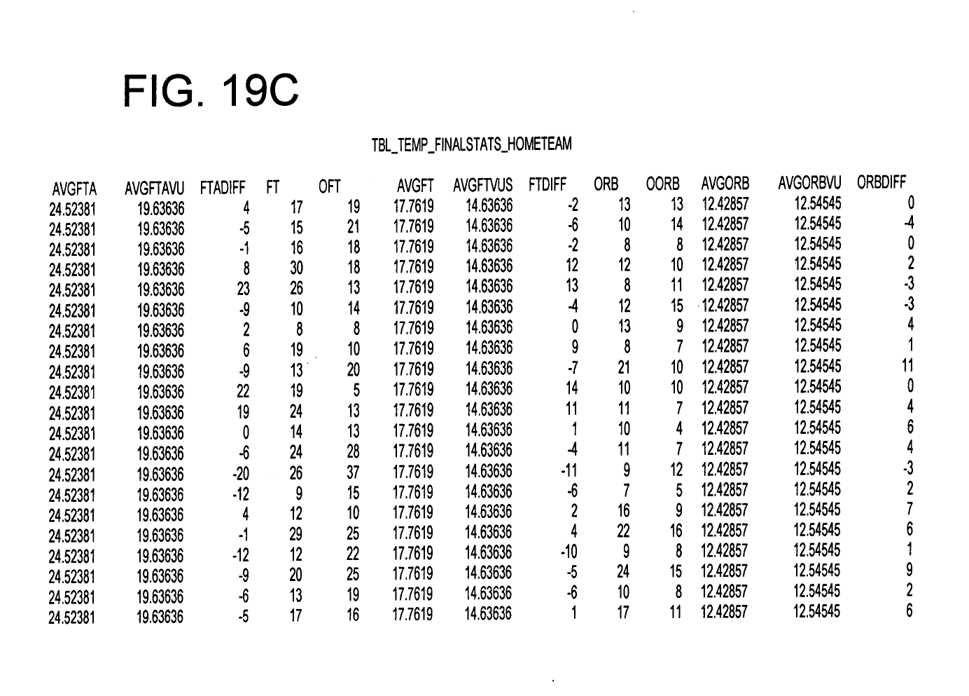

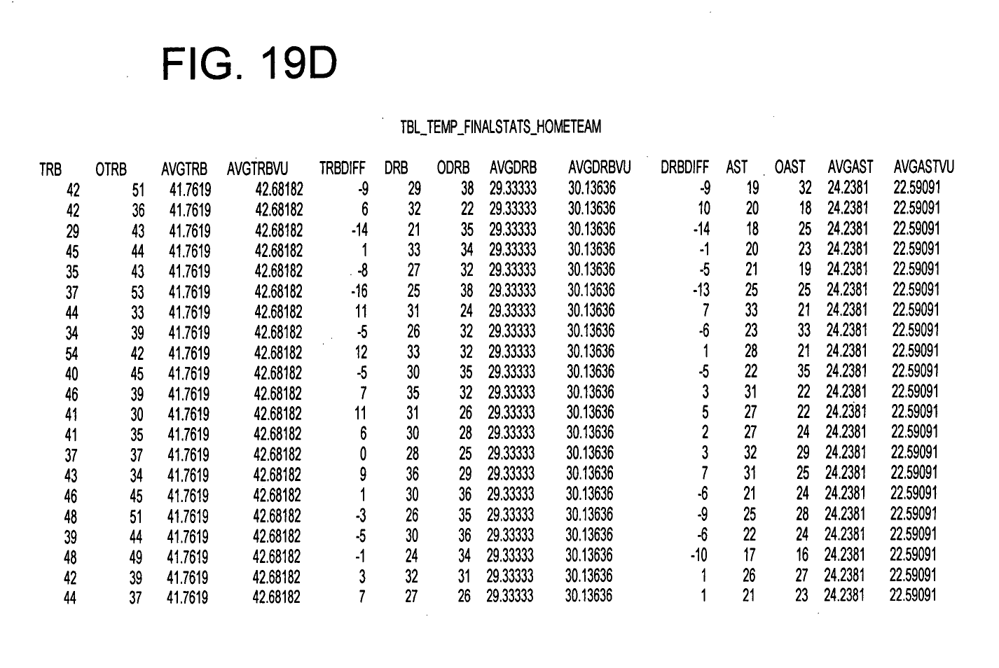

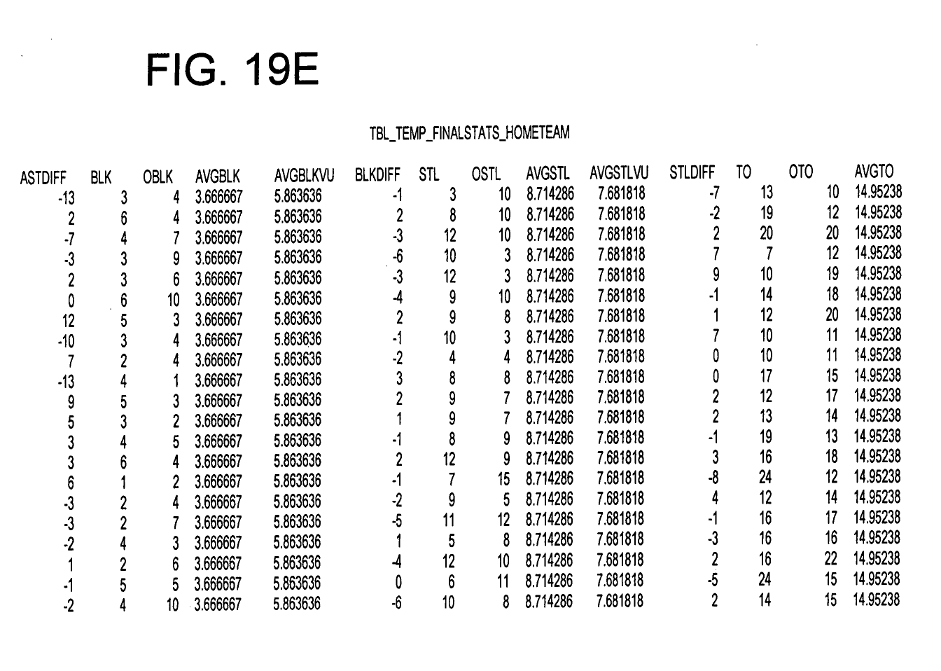

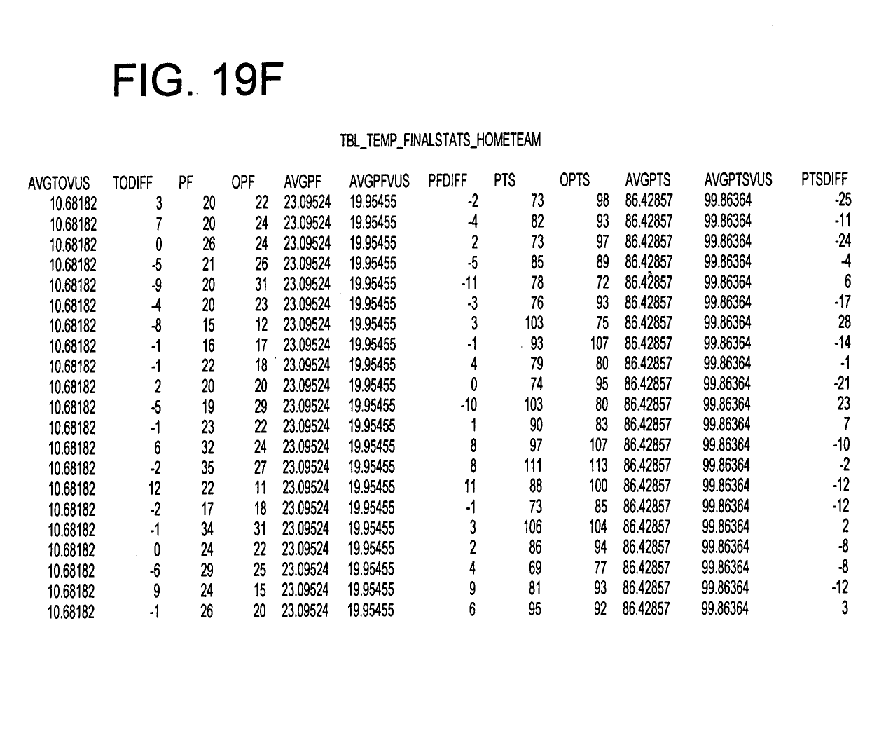

The program further has a code segment for generating a GUI image of a graph chart having a first and second axis. The first axis of the chart identifies a series of incremental magnitudes associated with a sports statistic, and the second axis identifies a series of time increments. A code segment plots the transmitted sports data at a point corresponding to a correlative magnitude and point in time on the GUI image. Thus, the computer program plots a series of data points corresponding to a particular sports statistic that occurred over a given time. In a preferred embodiment, the graphical image generated by the computer program appears as a line graph displaying a player or team performance over a specific time interval. Examples of some of the graphs that the program is adapted to generate are illustrated in FIG. 1.

The graph chart can be adapted to display several different statistical graphs including comparative graphs of home versus road wins and losses over a given time interval. For example, the graph chart can depict wins and losses for all home team games and all road team games over a given time to help a user deduce trends of either team. The software can also generate a graph charting a home team's home games versus a road team's road games over a time frame to help a user deduce and quantify the advantage of the team playing at home. A graph can alternatively chart only games with a particular one of the home team's starting pitchers versus road games with the road team's specified starting pitcher over the course of a specified time period. It is appreciated that these are only a few examples of match-ups the software is capable of generating and the invention should not be limited to the match-up scenario described herein. Moreover, the software is capable of generating graphs depicting a variety of statistical trends relating and applying the statistical trend to a broad array of match-up scenario.

The present computer program is also capable of generating line graphs corresponding to various statistical data differentials. For example, the computer program can plot the margin between the actual stats of two teams or between the two teams' actual stats and their respective opponents' actual stats or the average margin between two teams as it relates to a given statistical category. Thus, the computer program can generate graphs that chart statistics other than actual magnitude of a particular statistic.

When obtaining a graph of the differential between two teams, the computer program is adapted to display a “point-spread” or “run-line” on the same interactive graph as the statistical data. The point-spread and/or run-line indicates a number of points/runs by which a stronger player or team can be expected to defeat a weaker player or team in either a particular statistical category or in overall competition. As is known, the point-spread and/or run-line is added to the weaker player or team's actual points, and the new magnitude is then compared to the stronger player or team's actual points/runs to determine a winning speculative wager. Because a point-spread and/or run-line is an officially established figure, it is transmitted to the program from a database wherein the point-spread and/or run-line has been predetermined by sanctioned odds makers. Once the computer program receives the point-spread and/or run-line transmission from the database, it generates an image on the graph chart displaying the point spread to help a user visualize the concept of speculation.

Additionally, the computer program incorporates a feature that displays relevant data to a user if the user places a cursor on a data point plotted on the graph. For example, a user having graphed the number of turnovers for a particular team over the course of a half-season, can place a cursor on a given generated data point. The software then generates an image displaying the Opponent played by the selected team on a particular day as well as any other meaningful data.

All of the features of the invention that are discussed above could all be present in a single system. However, the invention also embraces systems and methods that implement only a subset of these features. Further, the features that have been discussed thus-far are merely illustrative of the invention, not exhaustive. For example, although having been discussed in the context of the Internet, it is to be understood that the invention is also applicable to other types of networked communication systems, such as local area networks (LAN), wide area networks (WAN) and point-to-point dial up connections. Also, a server system can comprise any combination of hardware or software that can interact with the server system. These systems can include television-based systems or various other consumer products through which information may be retrieved.

While specific embodiments have been illustrated and described, numerous modifications come to mind without significantly departing from the spirit of the invention and the scope of protection is only limited by the scope of the accompanying claims.

1. A method for graphing sport statistics using a computer software application, the method comprising the steps of:
providing a plurality of input fields, wherein at least one of the plurality of input fields is adapted to receive sports data corresponding to at least a first sport entity, at least one of the input fields is adapted to receive at least a first desired time interval, and at least one of the input fields is adapted to receive at least one desired sport statistic;
accessing a database storing sport data, wherein the sport data comprises a plurality of statistical events occurring at a point in time, each statistical event corresponding to one of a plurality of sport entity identifiers, wherein each of the sport entity identifiers is one of either a player and a team;
receiving an input transmission of at least one sport entity identifier, wherein the sport entity identifier corresponds to one of either a player and a team;
receiving an input transmission of at least one time interval, the at least one time interval comprising a fixed beginning point in time and a fixed ending point in time. receiving an input transmission of at least one desired sport statistic;
receiving an input transmission from the database, wherein the input transmission from the database comprises a plurality of sport data corresponding to the at least one sport entity identifier, the at least one time interval, and the at least one desired sport statistic;
generating a graphical user interface image of a graph chart, the graph chart comprising a first and second axis, wherein the first axis of the chart identifies a series of incremental magnitudes associated with a sport statistic and the second axis identifies a series of time increments;
plotting the transmitted sport data at a point corresponding to a correlative magnitude and point in time on the graphical user interface image, and,
generating a graphical representation of the at least one desired sport statistic over the at least one time interval and corresponding to the at least one sport entity identifier.

2. A computer program for graphing sport statistics, the computer program comprising:
a first code segment for accessing a database storing sport data, wherein the sport data comprises a plurality of statistical events occurring at a point in time, each statistical event corresponding to one of a plurality of sport entity identifiers, wherein each of the sport entity identifiers is one of either a player and a team;
a second code segment for receiving an input transmission of at least one sport entity identifier, wherein the sport entity identifier corresponds to one of either a player and a team;
a third code segment for receiving an input transmission of at least one time interval, the at least one time interval comprising a fixed beginning point in time and a fixed ending point in time.
a fourth code segment for receiving an input transmission of at least one desired sport statistic;
a fifth code segment for receiving an input transmission from the database, wherein the input transmission from the database comprises a plurality of sport data corresponding to the at least one sport entity identifier, the at least one time interval, and the at least one desired sport statistic;
a sixth code segment for generating a graphical user interface image of a graph chart, the graph chart comprising a first and second axis, wherein the first axis of the chart identifies a series of incremental magnitudes associated with a sport statistic and the second axis identifies a series of time increments; and,
a seventh code segment for plotting the transmitted sport data at a point corresponding to a correlative magnitude and point in time on the graphical user interface image, and generating a graphical representation of the at least one desired sport statistic over the at least one time interval and corresponding to the at least one sport entity identifier.

3. A method for graphing sport statistics using a computer system application, the method comprising the steps of:
providing a system server, the system server being in operable communication with a database storing sport data, wherein the sport data comprises a plurality of statistical events occurring at a point in time, each statistical event corresponding to one of a plurality of sport entity identifiers, wherein each of the sport entity identifiers is one of either a player and a team;
providing a web interface being operably connected to the system server;
providing a plurality of input fields, the input data fields being displayed on the web interface, the input data comprising at least one sport entity identifiers corresponding to a sport entity, at least one desired time interval, at least one desired sport statistic;
displaying a prompt on the web interface prompting an input transmission of a first sport entity identifier;
displaying a prompt on the web interface prompting an input transmission of a first time interval;
displaying a prompt on the web interface prompting an input transmission of a desired sport statistic;
receiving an input transmission from the database, wherein the input transmission from the database comprises a plurality of sport data corresponding to the first sport entity identifiers, time interval, and sport statistic;
generating a graphical user interface image of a graph chart, the graph chart having a first and second axis, wherein the first axis of the chart identifies a series of incremental magnitudes associated with a sport statistic and the second axis identifies a series of time increments;
plotting the transmitted sport data at a point corresponding to a correlative magnitude and point in time on the graphical user interface image; and, generating a graphical representation of the at least one desired sport statistic over the at least one time interval and corresponding to the at least one sport entity identifier.
